(19) United States
(12) Patent Application Publication
(10) Pub. No.: US 2017/0321062 A1
(43) Pub. Date: Nov. 9, 2017

(54) GLITTER-CONTAINING COHESIVE PRODUCTS AND METHOD FOR MAKING THE SAME

(71) Applicant: Andover Healthcare Resources, Inc., Portsmouth, NH (US)

(72) Inventors: Thomas S. Murphy, Hillsboro Beach, FL (US); Khaled El-Tahlawy, Portsmouth, NH (US)

(21) Appl. No.: 15/589,330

(22) Filed: May 8, 2017

Related U.S. Application Data
(60) Provisional application No. 62/333,321, filed on May 9, 2016.

(51) Int. Cl. C09D 5/33; C09D 111/00; C09D 121/02; C09D 7/00; C09D 133/20; C09D 109/06; C09D 109/00; C09D 7/12; C08K 7/00; C08K 9/02; C08K 3/08

(52) U.S. Cl. CPC C09D 5/004; C09D 109/06; C09D 111/00; C09D 121/02; C09D 7/002; C09D 109/00; C09D 133/20; C08K 7/00; C08K 9/02; C08K 2201/003; C08K 3/08; C09D 7/1291

(57) ABSTRACT

In one aspect, a cohesive product comprises a substrate and a cohesive layer provided on at least one surface of the substrate. The cohesive layer comprises a cohesive composition including a cohesive component admixed with a glitter component. The cohesive component further comprising a thickening agent in an amount sufficient to maintain the glitter component substantially uniformly distributed in the cohesive composition. In a further aspect, a method of manufacturing a cohesive produce is provided.

### CROSS REFERENCE TO RELATED APPLICATIONS

This application claims the priority benefit of U.S. provisional application No. 62/333,321 filed May 9, 2016. The aforementioned application is incorporated herein by reference in its entirety.

### BACKGROUND

The present invention relates to cohesive products and, in particular, to cohesive products containing glitter to provide a sparkle visual effect and methods for making the same.

### SUMMARY

This disclosure is directed to cohesive products and, more particularly, to cohesive tapes, bandages, wraps, and so forth, that are impregnated or otherwise coated with a glitter-containing cohesive. Such a cohesive product may comprise one or more layers of a substrate and a cohesive formula containing glitter that is applied to the substrate.

The substrate may be formed of a single layer or multiple layers. Each layer may be a woven material, such as a woven, knitted, warp-knit, and warp-knit weft-insertion material, or, a nonwoven material. The substrate may be formed of an elastic or inelastic material. In preferred embodiments, the substrate includes a first layer comprising a warp-knit elastic yarn material and a second layer comprising a nonwoven material. In a preferred tape/bandage, the substrate comprises one or more layers formed of nylon or polyester.

In one embodiment, the present disclosure provides a cohesive tape or bandage comprising one or more layers of a substrate and a cohesive material in which the cohesive material comprises a natural rubber latex.

In another embodiment, the present disclosure provides a cohesive tape or bandage comprising one or more layers of substrate and a cohesive material in which the cohesive material comprises a synthetic water-based elastomer. Exemplary synthetic cohesive polymers include, for example, polychloroprene, polyisoprene, polybutadiene, butadiene-styrene, acrylonitrile polymers, and so forth. The synthetic water-based cohesive polymer defines at least one outer surface of the tape or bandage, and is usually applied to the substrate in such a way as to provide a cohesive surface on both the opposite sides of the product. It will be recognized that other latex-free cohesive formulas may be possible.

In one aspect, a cohesive product comprises a substrate and a cohesive layer provided on at least one surface of the substrate. The cohesive layer comprises a cohesive composition comprising a cohesive component admixed with a glitter component. The cohesive component further comprises a thickening agent in an amount sufficient to maintain the glitter component substantially uniformly distributed in the cohesive composition.

In a further aspect, a method of manufacturing a cohesive product, comprises providing a substrate and applying a cohesive composition to at least one surface of the substrate. The cohesive composition comprises a cohesive component admixed with a glitter component and a thickening agent in an amount sufficient to maintain the glitter component substantially uniformly distributed in the cohesive composition. In still a further aspect, a cohesive product manufactured by the foregoing process is provided.

The glitter cohesive application process of the present application is applicable to latex or latex-free tapes, bandages, or any number of other cohesive products to successfully and effectively add glitter to such products.

### BRIEF DESCRIPTION OF THE DRAWINGS

The invention may take form in various components and arrangements of components, and in various steps and arrangements of steps. The drawings, which are not necessarily to scale, are only for purposes of illustrating certain preferred embodiments, and are not to be construed as limiting the invention.

FIG. 1 is a side view of an exemplary tape or bandage roll with glitter formed in accordance with the present disclosure.

FIG. 2 is a fragmentary view taken generally from above of a tape or bandage with glitter cohesive applied to the substrate.

FIG. 3 illustrates a schematic diagram of a portion of an apparatus for manufacturing multi-layer latex or latex-free glitter tape or bandage.

FIG. 4 illustrates a schematic diagram of a portion of an apparatus for manufacturing a single layer latex or latex-free glitter tape or bandage.

FIG. 5 is a cross-sectional view of an exemplary cohesive product having a three layer substrate in accordance with an exemplary embodiment of the invention.

### DETAILED DESCRIPTION OF THE PREFERRED EMBODIMENT(S)

Cohesive products such as cohesive tape or bandages are frequently used in medical, veterinary, and sports applications, e.g., for wound or injury care or the like. Besides the functional design features of such tape and bandages, one advantage of the present development is that it provides cohesive products having an aesthetically appealing appearance. In certain embodiments, glitter is added for appearance purposes to make the tape or bandages shimmer and/or sparkle. Conventional methods of manufacturing cohesive products such as tapes or bandages involve dipping the substrate into a dip tank containing the cohesive formula, e.g., using a roller submerged in a tank containing a cohesive formulation, and passing the substrate around and/or through sets of rollers. However, in reducing the present development to practice, the present inventors have found that merely adding glitter to the cohesive formula in such dip tanks has several problems. In particular, the rollers used in the process tend to undesirably attract the glitter particles, thereby interfering with the distribution of glitter on the tape/bandage and, for example, causing uneven distribution of the glitter in the tank and/or on the tapes or bandages.

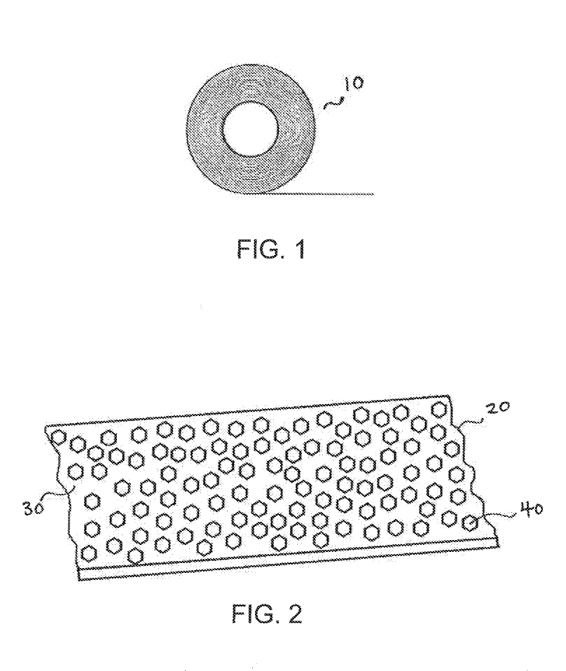

Referring more particularly to the drawings, FIG. 1 is a side view of a roll of tape or a bandage roll, generally designated 10. FIG. 2 is a fragmentary view of a tape or bandage showing the substrate 20 with cohesive material 30 containing glitter 40 applied thereon. Although a cohesive product having a single layer substrate is shown in the illustrated embodiment appearing in FIG. 2, it will be recognized that cohesive products having multilayer substrates are also contemplated.

It will be recognized that the substrate may comprise one or more layers and any of the one or more layers of substrate may be made from any of a wide range of materials, and may have a wide range of structures. In embodiments in which the cohesive product of the present invention is a tape or bandage, the substrate typically will comprise a woven, knitted, or warp-knit (e.g., warp-knit, weft insertion) fabric, or a non-woven fabric such as a non-woven scrim, of either natural or synthetic fiber. The substrate structure also may be elasticized by knitting or weaving elastic threads into one or more of the layers, or by knitting or sewing elastomeric threads through a single or multi-layer substrate.

As previously discussed, known manufacturing processes for cohesive tapes or bandages often involve a dip tank using a nip and dip process. The mere addition of glitter to the cohesive formulation in such a process is not effective or efficient in applying glitter to the substrate. It has been found that by increasing the viscosity of the cohesive to at least 4,000 cP, the glitter remains substantially uniformly distributed in the cohesive and can be applied uniformly using a manifold just before the substrate enters into the nip of a pair of opposing nip rollers.

In a preferred embodiment, the viscosity of the cohesive containing glitter is increased by adding a suitable polyacrylate based thickening agent. Exemplary thickening agents include, but are not limited to, PARAGUM® 500 and PARAGUM® 184 available from Para-Chem, Simpsonville, S.C.

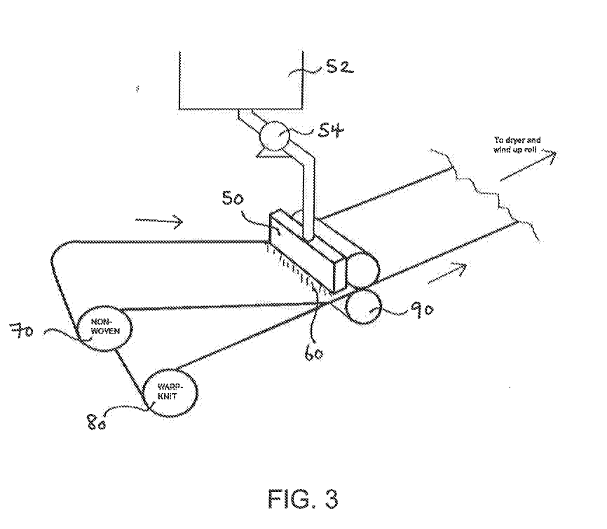

Referring to FIG. 3, in an illustrated preferred embodiment, there is a specially designed manifold 50 that applies the glitter-containing cohesive material 60 just before the substrate enters the nip rollers 90. In certain embodiments, the substrate is composed of a first layer comprising a nonwoven material 70 and a second layer comprising a warp knit yarn 80. It will be recognized that other numbers of substrate layers and other combinations of substrate materials are contemplated.

In a manufacturing process for cohesive tapes or bandages, instead of employing a dip tank to apply a cohesive material comprising an elastomer to the substrate, there is employed a specially designed manifold 50 containing the cohesive composition comprising a cohesive component and glitter component. The manifold 50 provides for continuous and even coverage of the glitter-containing cohesive material 60 on the substrate. The glitter cohesive material 60 is applied to the substrate just before entering the nip of a pair of nip rollers 90. The glitter cohesive material 60 may be applied by being fed onto the substrate. In the illustrated embodiment of FIG. 3, the cohesive material is fed to the manifold 50 from a storage tank 52 at a controlled rate by a pump 54 or other means for conveying the viscous cohesive material, such as an extruder or the like. Other means of conveying the cohesive material from the storage tank to the manifold may be used, including, but not limited to, a drip-fed system with a pressurized storage tank or a gravity fed system. From there, the substrate may then pass to a dryer or other processing steps as needed to produce the desired end product, which may include evaporating the water or other solvent components from the cohesive. The dried cohesive product may be wound up onto a windup roll. The windup roll then may be cut to provide tape rolls having a desired width.

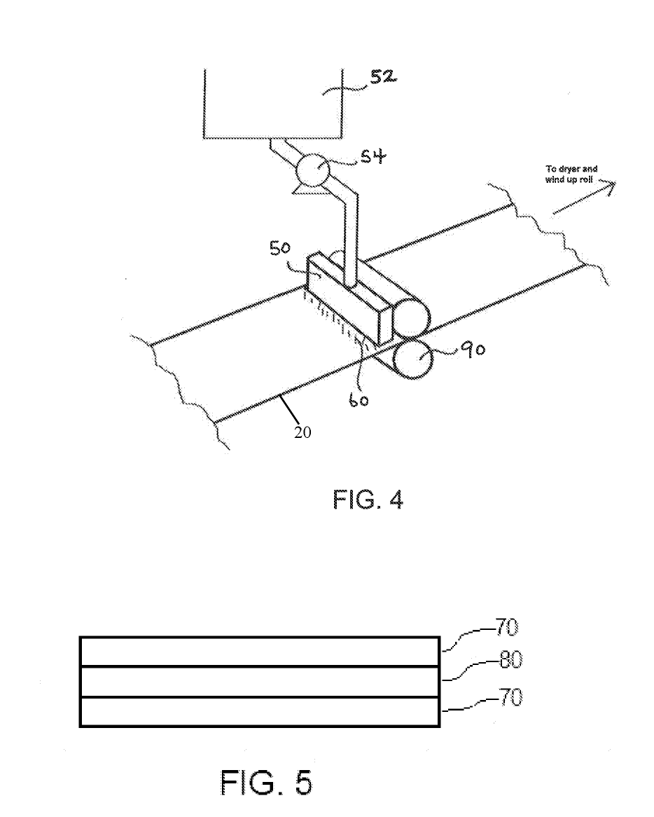

Referring to FIG. 4, an exemplary method for making a cohesive product wherein the substrate is a single layer of material is illustrated. A manifold 50 containing the cohesive material with an elastomer as well as glitter is used to apply the glitter-containing cohesive material 60 is to the substrate 20 just before the substrate enters the nip of a pair of nip rollers 90. The glitter-containing cohesive material 60 may be applied by being fed onto the substrate. The cohesive material is fed to the manifold 50 from a storage tank 52 at a controlled rate by a pump, extruder, or the like 54. From there, the substrate may then pass to a dryer or other processing steps as needed to produce the desired end product, which may include evaporating the water or other solvent components from the cohesive. The dried cohesive product may be wound up onto a windup roll. The windup roll then may be cut to provide tape rolls having a desired width.

In a further embodiment, shown in FIG. 5, a substrate for a cohesive product such as a cohesive bandage or cohesive tape includes first and third layers 70, each formed of a nonwoven fabric, which may be the same or different, and a third layer 80 which is elastic in a direction extending longitudinally of the bandage. The third layer is disposed between the first and second layers. In certain embodiments, the third layer is a warp-knit layer which is elastic in a direction extending longitudinally of the bandage.

In certain alternative embodiments, the substrate is initially impregnated with a cohesive material that does not contain glitter. The cohesive material may be applied by being fed onto the substrate, for example, through a manifold as previously described. Alternatively, a nip and dip process is also contemplated, wherein the substrate is dipped into a dip tank containing the cohesive formulation. After the substrate has been impregnated with a cohesive material, glitter particles are applied to the substrate before the substrate passes to a dryer and/or other processing steps needed to produce the desired end product, which may include evaporating the water or other solvent components from the cohesive. The dried cohesive product may be wound up onto a windup roll. The windup roll then may be cut to provide tape rolls having a desired width.

In certain embodiments, the cohesive product comprises a substrate and a cohesive composition comprising a natural rubber latex. Such a cohesive composition is, for example, made from a water-based emulsion of a natural rubber latex to which a tackifier and glitter has been added. The viscosity of the cohesive is increased by adding a suitable polyacrylate based thickening agent. The resulting latex/tackifier structure is applied to the substrate, preferably by saturating the substrate with the emulsion or coating the emulsion onto the opposite sides of the substrate using the manifold system as described above. The substrate is then dried to produce the desired end product.

In certain alternative embodiments, the cohesive product comprises a substrate and a cohesive composition comprising a synthetic water-based elastomer, as described in U.S. Pat. No. 6,156,424 (U.S. application Ser. No. 08/961,801, filed Oct. 31, 1997), the entire contents of which are incorporated herein by reference. As described in this prior patent, the bandages or other cohesive products may be made using the same general manufacturing techniques as with natural rubber latex, except where the elastomer is a synthetic water-based elastomer rather than natural rubber latex, and different tackifiers and/or quantities of tackifier are employed to enhance the cohesive property of the elastomer by disruption of the crystalline structure and to maintain the cohesive material in the desired partial polycrystalline state. It will be recognized that other latex-free cohesive formulas also be employed.

The glitter added to the cohesive formula may be any number of small, generally flat, reflective particles that reflect light and cause the surface of the bandage to sparkle or shine. In preferred embodiments, the glitter is composed of cut up multilayer polyester film with polymer, color, and reflective materials. The preferred range of sizes of each glitter particle is between about 0.025″ and 0.05″. The glitter particles may be cut in any desired shape, including geometric and non-geometric shapes, such as, but not limited to, circles, triangles, squares, hexagons, polygons, hearts, stars, etc. The glitter particles may also comprise any combination of a plurality of shapes. Although the actual composition may vary depending on the particular elastomer cohesive, some illustrative cohesive formulations contain about 8% to 10% weight percentage of glitter and have a viscosity of about 4,000 to 20,000 centipoise (cP) at room temperature (70° F. or 21° C.). In preferred embodiments, the viscosity of the cohesive formulation is greater than or equal to about 8,000 cP at room temperature. In certain embodiments, the coating density range of the cohesive composition after drying is in the range of from about 40-60 g/m².

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A cohesive product comprising a substrate and a cohesive layer provided on at least one surface of the substrate, the cohesive layer comprising a cohesive composition comprising a cohesive component admixed with a glitter component, the cohesive component further comprising a thickening agent in an amount sufficient to maintain the glitter component substantially uniformly distributed in the cohesive composition.

2. The cohesive product of claim 1, wherein the cohesive composition has a viscosity of 4,000 centipoise (cP) or greater at 21° C. prior to drying.

3. The cohesive product of claim 1, wherein the cohesive composition has a viscosity of 8,000 to 20,000 cP at 21° C. prior to drying.

4. The cohesive product of claim 1, wherein the cohesive product is selected from the group consisting of a cohesive tape and a cohesive tape.

5. The cohesive product of claim 1, wherein the cohesive component comprises a polymeric material selected from the group consisting of a synthetic water-based elastomer, a rubber latex, polychloroprene, polyisoprene, polybutadiene, butadiene-styrene polymer, and acrylonitrile polymer.

6. The cohesive product of claim 1, wherein the glitter component is formed of a material selected from the group consisting of: a polymeric material, a metal, a metal coated polymer film, a metal coated paper, and any combination thereof.

7. The cohesive product of claim 1, wherein the substrate is a single layer substrate.

8. The cohesive product of claim 1, wherein the substrate is a multiple layer substrate.

9. The cohesive product of claim 1, wherein the substrate is selected from the group consisting of nylon and polyester.

10. The cohesive product of claim 1, wherein the cohesive composition comprises from about 8 to 10 percent by weight of the glitter component.

11. The cohesive product of claim 1, wherein the glitter component comprises glitter particles having a mean diameter in the range of 0.025 inches (0.635 cm) to 0.05 inches (1.27 cm).

12. The cohesive product of claim 1, wherein the glitter component comprises glitter particles which are substantially flat and have a peripheral shape selected from the group consisting a circle, triangle, square, rectangle, hexagon, polygon, heart shape, and star shape, and combinations thereof.

13. The cohesive product of claim 1, wherein said thickening agent is a polyacrylate based thickening agent.

14. The cohesive product of claim 1, wherein a coating density of the cohesive composition on the substrate after drying is in the range of from about 40 g/m² to 60 g/m².

15. A method of manufacturing a cohesive product, comprising:
providing a substrate; and
applying a cohesive composition to at least one surface of the substrate wherein said cohesive composition comprises a cohesive component admixed with a glitter component, the cohesive composition further comprising a thickening agent in an amount sufficient to maintain the glitter component substantially uniformly distributed in the cohesive composition.

16. The method of claim 15, wherein said step of applying a cohesive composition includes feeding said cohesive composition from a source of the cohesive composition to an inlet of a manifold, said manifold having a plurality of outlets adjacent to the at least one surface of the substrate and in fluid communication with the inlet.

17. The method of claim 15, further comprising:
after applying the cohesive composition to the at least one surface of the substrate, passing the substrate through a pair of nip rollers; and
after passing the substrate through the pair of nip rollers, drying the cohesive product.

18. The method of claim 15, wherein the cohesive composition has a viscosity of 4,000 cP or greater at 21° C. prior to drying.

19. The method of 15, wherein the cohesive composition has a viscosity of 8,000 to 20,000 cP at 21° C. prior to drying.

20. The method of claim 15, wherein the cohesive product is selected from the group consisting of a cohesive tape and a cohesive bandage.

21. The method of claim 15, wherein the cohesive component comprises a polymeric material selected from the group consisting of a synthetic water-based elastomer, a rubber latex, polychloroprene, polyisoprene, polybutadiene, butadiene-styrene polymer, and acrylonitrile polymer.

22. The method of claim 15, wherein the glitter component is selected from the group consisting of polymeric material, metal, metal coated polymer film, metal coated paper, and any combination thereof.

23. The method of claim 15, wherein the substrate is a single layer substrate.

24. The method of claim 15, wherein the substrate is a multiple layer substrate.

25. The method of claim 15, wherein the substrate is selected from the group consisting of nylon and polyester.

26. The method of claim 15, wherein the cohesive composition comprises from about 8 to 10 percent by weight of the glitter component.

27. The method of claim 15, wherein the glitter component comprises glitter particles having a mean diameter in the range of 0.025 inches (0.635 cm) to 0.05 inches (1.27 cm).

28. The method of claim 15, wherein the glitter component comprises glitter particles which are substantially flat and have a peripheral shape selected from the group consisting a circle, triangle, square, rectangle, hexagon, polygon, heart shape, and star shape, and combinations thereof

29. The method of claim 15, wherein the glitter particles have a peripheral shape selected from the group consisting a circle, triangle, square, rectangle, hexagon, polygon, heart shape, and star shape, and combinations thereof.

30. The method of claim 15, wherein a coating density of the cohesive composition on the substrate after drying is in the range of from about 40 g/m² to 60 g/m².

31. The method of claim 15, wherein said thickening agent is a polyacrylate based thickening agent.

32. A cohesive product manufactured by a process comprising the steps of:
providing a substrate; and
applying a cohesive composition to at least one surface of the substrate wherein said cohesive composition comprises a cohesive component admixed with a glitter component, the cohesive composition further comprising a thickening agent in an amount sufficient to maintain the glitter component substantially uniformly distributed in the cohesive composition.
